(19) United States
(12) Patent Application Publication
(10) Pub. No.: US 2007/0260474 A1
(43) Pub. Date: Nov. 8, 2007

(54) COMMERCIALIZATION CENTER

(76) Inventors: Paul E. Arlton, West Lafayette, IN (US); David J. Arlton, West Lafayette, IN (US)

Correspondence Address: BARNES & THORNBURG LLP, 11 SOUTH MERIDIAN, INDIANAPOLIS, IN, 46204, US

(21) Appl. No.: 11/620,559

(22) Filed: Jan. 5, 2007

Related U.S. Application Data
(60) Provisional application No. 60/743,101, filed on Jan. 6, 2006.

(51) Int. Cl. G06Q 30/00

(52) U.S. Cl. 705/1

(57) ABSTRACT

A method includes the steps of providing a student as a source of technology, providing a manufacturing facility to develop prototype products, obtaining an active profit unit (APU) and a passive profit unit (PPU) to pay overhead and operating costs of the manufacturing facility.

This application claims priority to U.S. Provisional Application No. 60/743,101 which was filed Jan. 6, 2006 and is hereby incorporated by reference herein.

### BACKGROUND

The present disclosure relates to production and commercialization of components of products and processes. More particularly, the present disclosure relates to a method for producing low-volume prototypical components.

Manufacturers often procure technological ideas and transform those ideas into prototypical components. It is desirable to control the production of such prototype components to minimize the monetary cost of doing so.

### SUMMARY

According to the present disclosure, a method is provided for establishing a technology commercialization center to produce prototypical components. The method may include the steps of procuring a source of technology, providing a captive manufacturing facility, and obtaining active and passive profit units to pay overhead costs of the captive manufacturing facility.

In illustrative embodiments, the technology commercialization center is located near a research institution to procure technology. The technology commercialization center uses aluminum molds and vertical clamp molding to produce injection molded prototypical components. The technology commercialization center further combines these components with electronic components to prototype useful products and processes.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a diagrammatic view showing exemplary components of a technology commercialization center in accordance with the present disclosure;

FIG. 2 is a perspective view of a prototypical component production center in accordance with the present disclosure;

FIG. 3 is a diagrammatic view of the technology commercialization center having a technology center and associated nodes of operation;

FIG. 4 is a perspective view of a vertical clamp molding machine of FIG. 2;

FIG. 5 is an exploded perspective view of components included in a mold clamp portion of the vertical clamp molding machine of FIG. 4;

FIG. 6 is another perspective view of the molding portion of the vertical clamp molding machine of FIG. 4;

FIG. 7 is a perspective view of a computer numerically controlled (CNC) milling machine;

FIG. 8 is an enlarged perspective view of an interchangeable spindle-speed increaser of FIG. 7;

FIG. 9 is a perspective view of a multi-axis horizontal turning center; and

FIG. 10 is a perspective view of electronics “pick-and-place” equipment.

### DETAILED DESCRIPTION

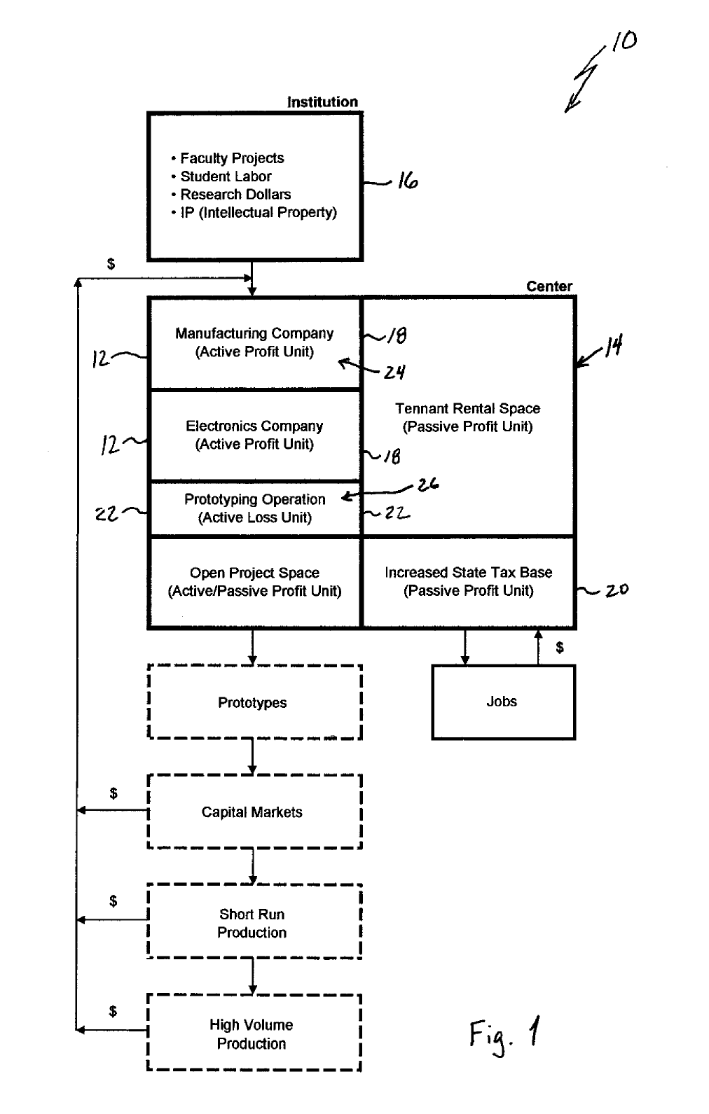

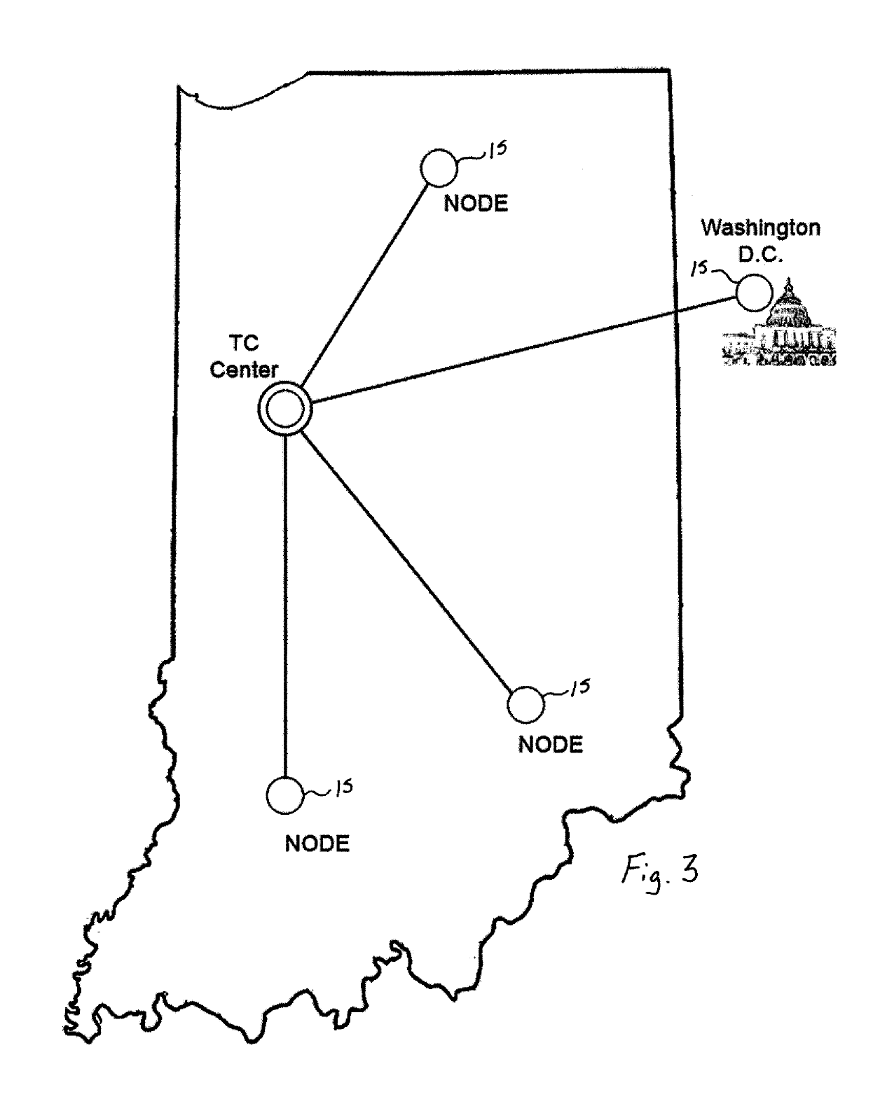

A technology commercialization center 10 (hereinafter “TCC”) includes business units 12 working individually, but considered for financial purposes as one system as suggested in FIG. 1. The input of TCC 10 may be intellectual property or technology in need of commercialization, and the output of TCC 10 is marketable products. TCC 10 concentrates manufacturing equipment and processes, along with manufacturing and marketing expertise in a central location 14 for ease of use and maintenance. In illustrative embodiments as suggested in FIG. 3, the elements of TCC 10 may be located in close physical proximity to allow business and technological interaction, or have virtual communications links for distant nodes 15.

It may be desirable to have income and expenses allocated within TCC 10 on the basis of the whole TCC 10 and not just as a grouping of individual profit centers. Overhead and labor costs of TCC 10 are spread among various business units 12 with the result that the total TCC 10 operates at about a break-even or a zero-profit point. Since it is not losing money, TCC 10 is a sustainable business entity that can operate without constant outside investment.

When comparing TCC 10 against a comparable investment, a state government will recognize that jobs created within the state along with associated tax revenues give TCC 10 a positive overall profitability, even if operating on a break-even basis. TCC 10 therefore compares favorably with other types of state investment opportunities in which jobs and tax revenues are not part of profitability calculations. An intangible value of TCC 10 is the opportunity for job growth when newly commercialized technologies enter a respective market. As these markets will often extend outside of the state boundaries, a resulting export base works to enhance this opportunity.

Since TCC 10 is created to operate with financially related business units 12, TCC 10 may be legally incorporated as a single legal business entity having a single set of financial records. Individual business units 12 may have any appropriate legal structure such as, for example, an S-Corp, limited-liability corporation, for-profit, or not-for-profit depending on the needs of a local community and technologies and markets being developed. TCC 10 may be a subcomponent of a university or other research institution 16.

In illustrative embodiments, TCC 10 has Active Profit Units (APU) 18, Passive Profit Units (PPU) 20, and Loss Units (LU) 22, as suggested, once again, in FIG. 1. APUs 18 may have an active role in the operation of TCC 10 and provide positive income to support the operations of TCC 10. For example, a manufacturing company 24 located in and paying rent to TCC 10 could be an APU 18. University-sponsored faculty research projects and university programs that pay fees to TCC 10 to support student laboratories are also APUs 18.

PPUs 20 may benefit directly or indirectly from total activities or facilities of TCC 10 but derive their income passively such as, for example, through rental of storage space. Profitable tenant rental space located peripherally around TCC 10 for companies that contribute to TCC 10 or use services of TCC 10 are examples of PPUs 20. Student classroom or learning areas located peripherally around TCC 10 can be considered PPU's 20 if income, from student tuition, for example, helps to defray overhead costs for TCC 10 facilities.

An increase in a state tax base generated by long-term operation of TCC 10 is a feature of the current disclosure and is considered a PPU 20. It maybe desirable for a state government to increase taxable income and should be considered in financial performance calculations.

Prototyping operations 26 may operate at a loss and are considered an LU 22. TCC 10 is configured so that a total long-term profit generated by the APUs 18 and PPUs 20 is zero or positive. As such, TCC 10 may survive financially on its own and not require additional financial resources after an undetermined start-up period.

Research and educational institutions 16 may conduct research programs which are sponsored by governmental agencies such as, for example, the Department of Defense or the National Science Foundation. These research programs may generate intellectual property which may be used to support TCC 10. License fees and royalty income from intellectual property may be considered a passive source or income or PPU for TCC 10. Sponsored research may be counted on as a source of operating income or APU 18 for TCC 10. Location of TCC 10 in a technology research park in close proximity to a research institution 16 may increase an opportunity for interaction with research faculty or students and may provide long term income from sponsored programs.

Universities and other non-profit educational or research institutions 16 may contribute to cost reduction for TCC 10. Some universities may have capabilities and features that may be utilized in combination with a high technology or manufacturing organization to facilitate commercialization of new technologies. A student labor force may be used to reduce labor costs in TCC 10. An actual cost of student labor may be shared by the manufacturing company 24 which may pay a portion of a wage, the institution 16, which might contribute to the wage, and the student who pays a tuition and fees to participate in a university program as part of a learning project. For example, students in a CAD/CAM (computer aided design/computer aided manufacturing) design class may be employed to develop CAD models of prototypes for faculty and operate computer numerically controlled (CNC) machines 28 to make prototype parts and plastic injection-molds for plastic injection molding machines 30.

TCC 10 may be located in proximity to an engineering or science program in a research or educational institution such as, for example schools of engineering and biomedical sciences. The engineering and science programs generate intellectual property and technology in need of commercialization, providing input for TCC 10.

Manufacturing partners may be active partners in TCC 10. The manufacturing partner may have a business that actively uses manufacturing technologies required to make desired prototype products/processes and may have a reason to maintain such technologies without regard to the prototyping projects associated with TCC 10. Thus, overhead costs associated with maintaining a skilled workforce and expensive high-technology machines may be borne by on-going higher-volume manufacturing operations and not by relatively low-volume prototyping operations. The manufacturing partner can also provide guidance on business and marketing issues.

The manufacturing partner may generate active income for TCC 10 by way of rental payments to TCC 10 or otherwise reduces the fixed overhead of TCC 10 through equity or other investment in the facilities of TCC 10. In an illustrative embodiment, TCC 10 involves an unmanned aerial vehicle (UAV) business capable of designing and manufacturing mechanical components, designing and fabricating electronics circuit boards, and developing software.

Passive partners may interact with TCC 10 through payments of rents or other forms of passive income, or reduce the fixed overhead of TCC 10 through equity or other investment in facilities of TCC 10. Government economic development organizations that fund initial plant, property and equipment (PP&E) purchases for TCC 10 are examples of passive partners. A company that donates goods or services to TCC 10 in exchange for promotional or marketing exposure is another example of a passive partner.

Manufacturing methods employed by TCC 10 may depend on an industry or market being served by TCC 10, but should be capable of building prototypes and producing short and medium runs of new products for a range of industries and markets. Manufacturing equipment geared for producing about 1,000 to 20,000 pieces per year may be adequate for consumer products as well as for military products such as UAVs. This production capacity may be considered low-volume manufacturing for consumer products and may be desirable for prototyping products and processes.

Manufacturing technologies capable of producing high volume production (millions of pieces per year) may be undesirable for TCC 10 because they may not have flexibility. High volume machinery may be expensive to tool and may need to operate continuously, eliminating a possibility of open time within which to make prototypes.

Some commercial products may have a need for molded plastic parts or some type of electronic or electrical components. Small UAVs, with wing or rotor spans of less than about 8 to 10 feet, computing devices such as digital meters, and medium size biomedical devices (less than about 18 inches tall by 18 inches wide by 18 inches long), such as hand-held testing devices and laboratory equipment, require molded plastic parts, metal parts, and electronic circuit boards. Manufactured parts for these products are all of about the same size and may fit into a manufacturing “size envelope” about 18 inches tall by 18 inches wide by 18 inches long.

Small UAVs and medium-size biomedical devices may also have markets which support lower volume of about 100 to 10,000 units per year and higher price points of about hundreds to tens of thousands of dollars per unit with increased profit margins. Products having high prices and low-volume manufacturing may be compatible with prototyping operations where a small percentage of the profit margin may be used to support the prototyping operation. Therefore, a manufacturing facility for either small UAVs or medium-size biomedical devices, or other small or medium sized devices, may cover a wide range of prototypes and support a variety of industries and markets.

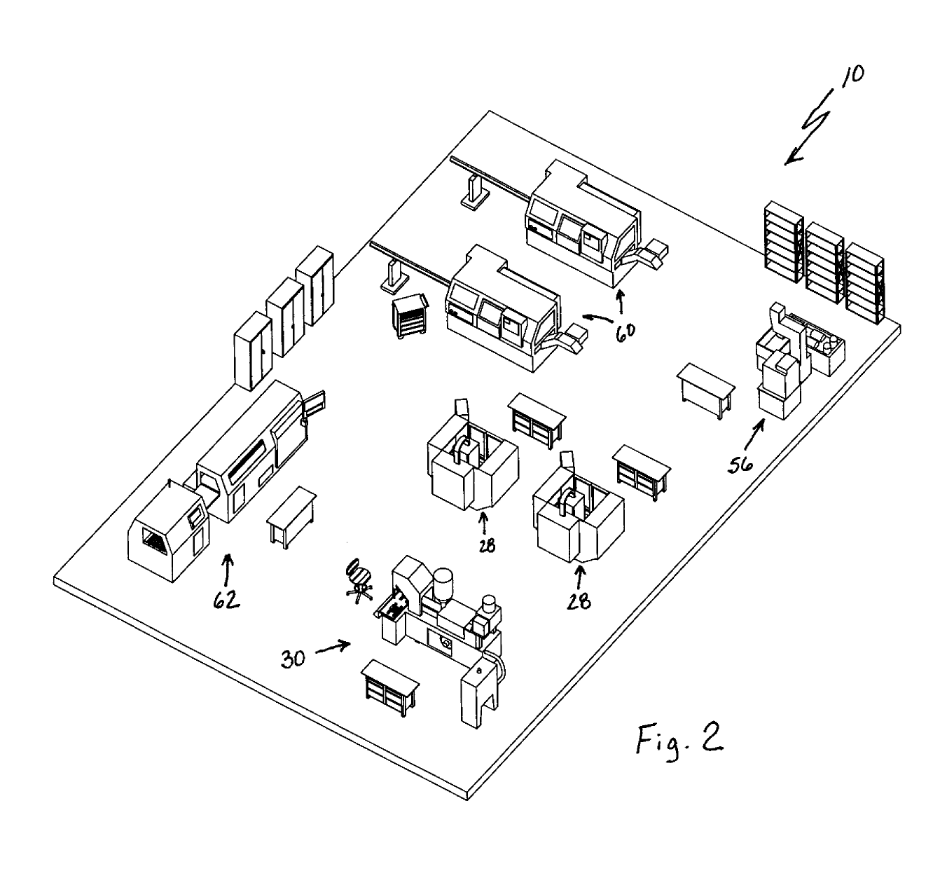

TCC 10 manufacturing operations may be located close to research and development departments to avoid processing delays and to facilitate communication between design and manufacturing engineers and technicians operating the prototyping equipment. In an illustrative embodiment shown in FIG. 2, an in-house (captive) capability to make molds for plastic injection molding machines is provided. These molds may be made of aluminum (such as alloy 7075 which is very hard and 6013 which may be inexpensive) and allow ease of cutting with CNC milling machines 28. High thermal conductivity of aluminum molds may be desirable since such molds generally require little cooling. Provisions for cooling the mold, such as refrigerative coolers or mold cooling channels may be eliminated by use of aluminum molds. This may reduce tooling costs for prototyping operations.

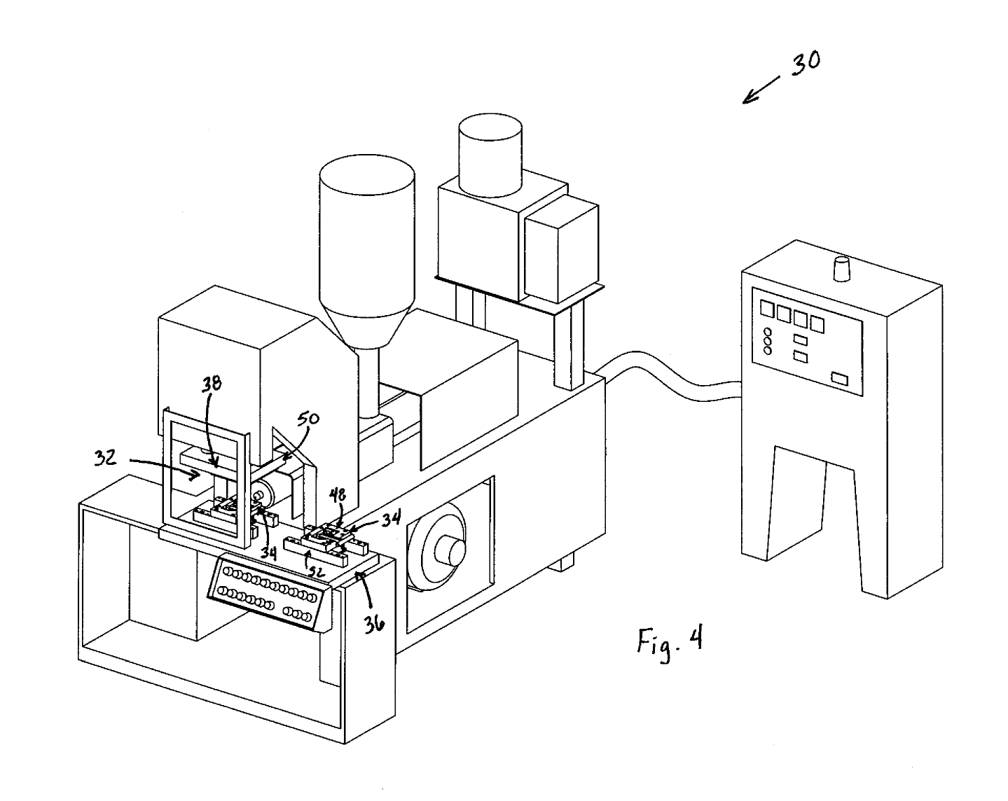

In illustrative embodiments, molding equipment known as “vertical-clamp” molding machines 30 are provided as shown in FIGS. 2 and 4. Plastic injection molding machines may be characterized by a direction in which the mold clamp opens and closes. Horizontally acting mold clamps on “horizontal” injection molding machines may be desirable for high-volume, low-low production because the machines may be operated without a human operator. In such machines, molded parts typically fall out of a clamp area and into a bin at an end of a molding cycle.

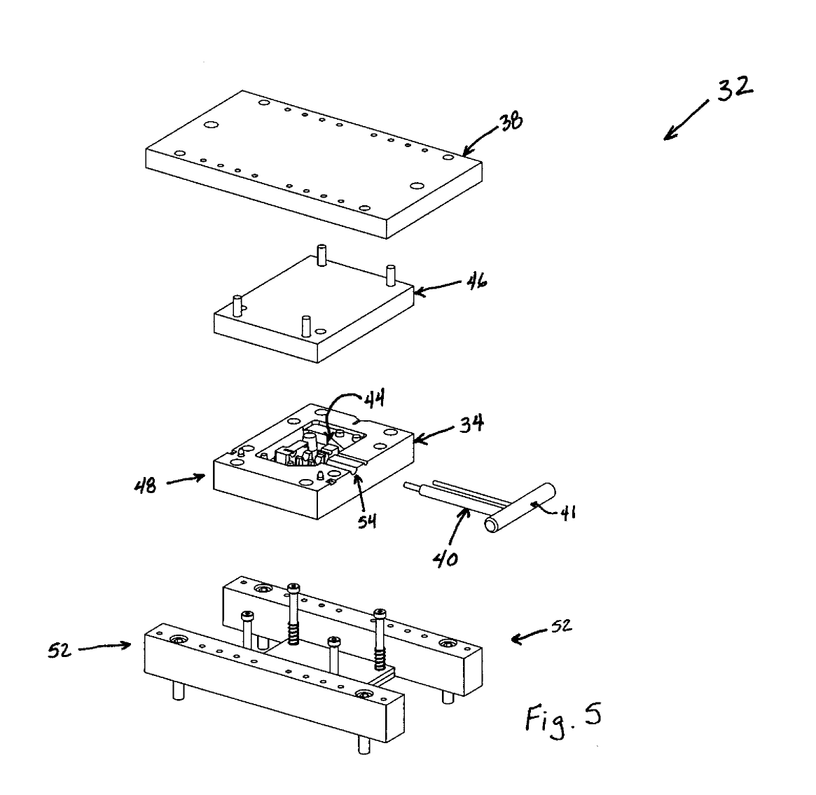

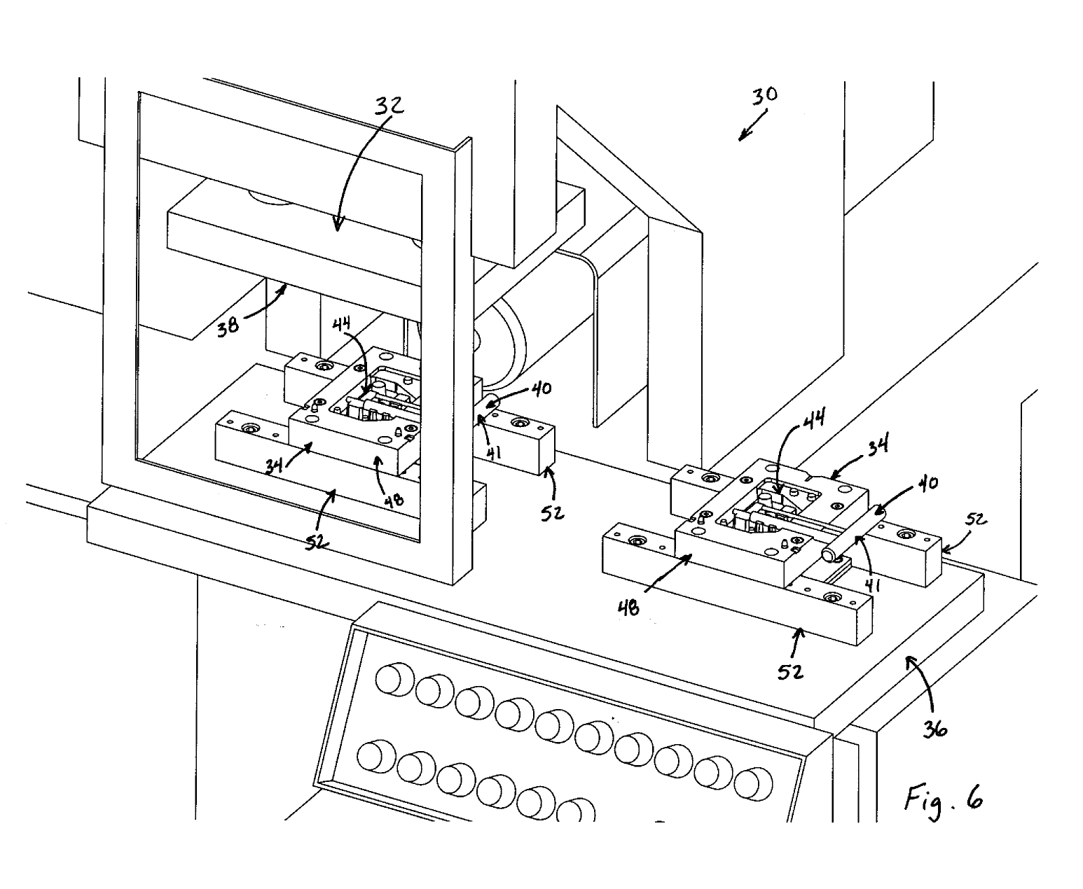

In illustrative embodiments, vertical molding machines 30 have a vertically acting mold clamp 32 and may be used for lower-quantity insert-molding operations where plastic is injected around a metal insert which has been is placed in a mold 34 prior to molding as shown best in FIG. 5. Referring now to FIGS. 4 and 6, plastic injection mold 34 on vertical molding machines 30 may be mounted to a rotary, or sliding shuttle table 36 that positions the mold within reach of an operator and then rotates or shuttles the mold into a clamp area 38 to perform a molding cycle. As such, hand-work on or near mold 34 such as to place inserts into mold 34 is facilitated.

It may be desirable for a human operator (not shown) in the molding process to manually manipulate mold inserts and core-pulls 40 immediately before and after the molding operation. This may reduce the cost of injection mold tooling especially when side core-pulls 40 are desired or required.

In other embodiments, interchangeable mold cavities and manually-operated core pulls 40 are provided. A large portion of a cost for mold 34 for plastic injection molding machines 30 may be the cost of a mold base (not shown) which supports mold cavities 44 in the molding machine 30. It may be desirable to use mold-plates 34 similar to multi-unit die molds (MUD) that simultaneously provide for interchangeable mold cavities 34 and side core-pulls 40 which are used to form hollow sections (not shown) inside of molded parts.

Mold plates 34 are pre-cut blocks of material such as aluminum that are made in top-and-bottom sets. The mold cavity 44 is formed (as with a CNC milling machine 28) on the inside surfaces of the top 46 and bottom 48 plates. Referring again to FIG. 4, top plate 46 is bolted to a top clamp 50 on molding machine 30, and bottom plate 48 is bolted to rails 52 mounted to the shuttle table.

Interchangeable mold plates 34 may be desirable over MUD molds because they provide surfaces at the edge of the mold plate to which a side core-pull handle 40 can be mounted. Manually operated side core-pulls 40 are generally comprised of a handle 41 appended to a core-pull (such as a wire rod) which is configured to form a hollow area on the inside of a molded plastic part.

In prototyping operations, core-pull 40 is placed in a slot 54 on mold plate 34 with its handle overhanging mold 34 as shown best in FIG. 6. Core-pull 40 is generally steel and held in place with magnets permanently imbedded in the mold surface. Shuttle table 50 transports the mold plate 34 to a location under the mold clamp 38 whereupon mold clamp 38 closes and the top and bottom halves 46, 48 of mold 34 close around the core. Plastic is injected under high pressure into mold 34 and around the core-pull. Once the molding cycle is complete, mold clamp 38 opens and the shuttle table moves mold 34 back to a position in front of the operator. The operator then manually pulls the core out of the plastic part and prepares for the next cycle. This method of producing hollow sections inside of plastic parts is generally less expensive and easier to design than are hydraulically or electrically actuated core-pulls.

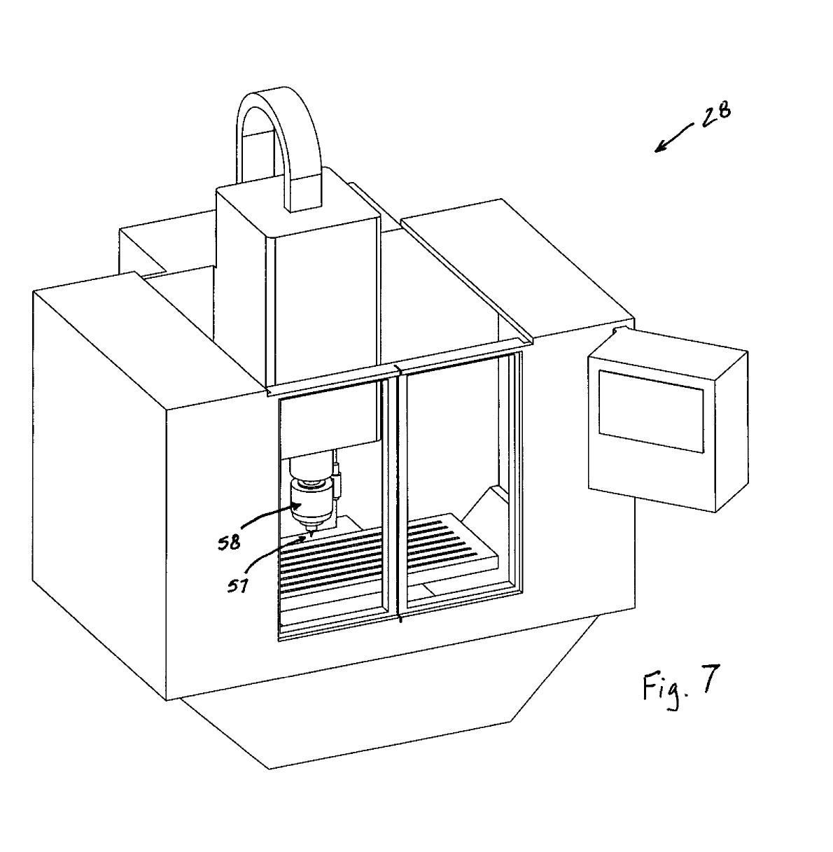

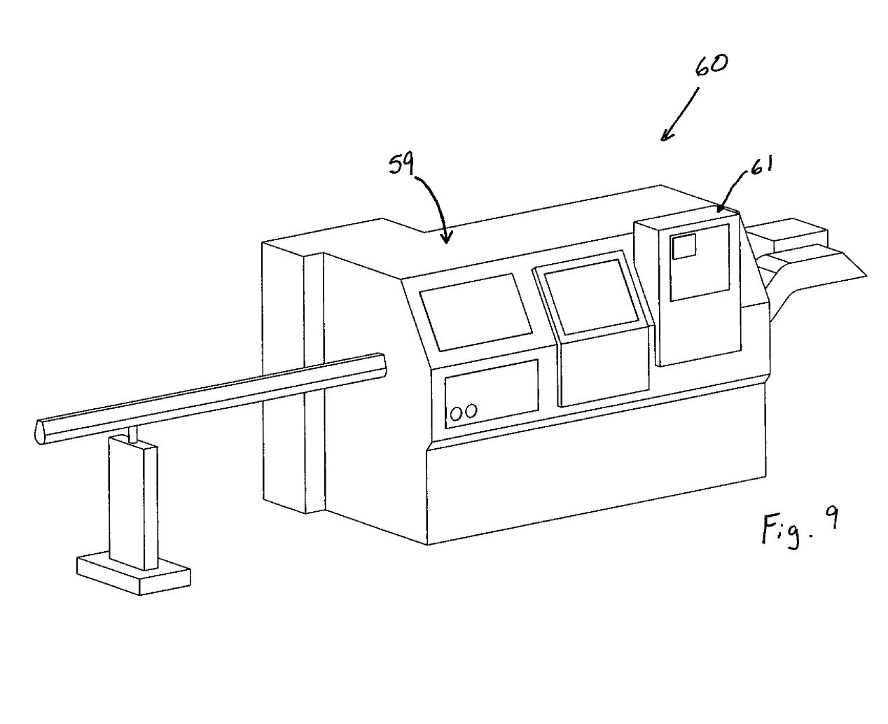

TCC 10 may have at least one computer numerically controlled (CNC) vertical machining center or milling machine 60 (shown in FIGS. 2 and 9) dedicated to making molds, and one plunge-style electric discharge machine (EDM) 56 for forming steel parts such as mold inserts as shown in FIG. 2. In an illustrative embodiment as shown in FIG. 7, a general purpose small milling machine such as the FADAL VMC 15 with a work area of 20 inches wide by 16 inches deep by 16 inches tall with a standard spindle (cutting head) speed of about 7500 PRM is provided. A generally low acquisition price of small milling machines may reduce the overall overhead cost of the prototyping operation.

A spindle speed of the milling machine of about 20,000 to 50,000 RPM is desirable. Molds generally require the use of very small cutting tools (mill bits with an end-radius of 1/32 inch or less) and very high spindle (cutting) speeds. Commercially available small, general purpose milling machines generally have spindle speeds in the range of about 5000 to 7500 RPM. This cutting speed range is too slow to cut with small milling tools (⅛ inches in diameter) and tightly spaced finishing passes that milling machines 28 must make in order to produce detailed molds and molded parts with smooth finishes. Some milling machines have options to increase spindle speeds, but have generally higher costs which may be prohibitive to low-cost prototyping operations.

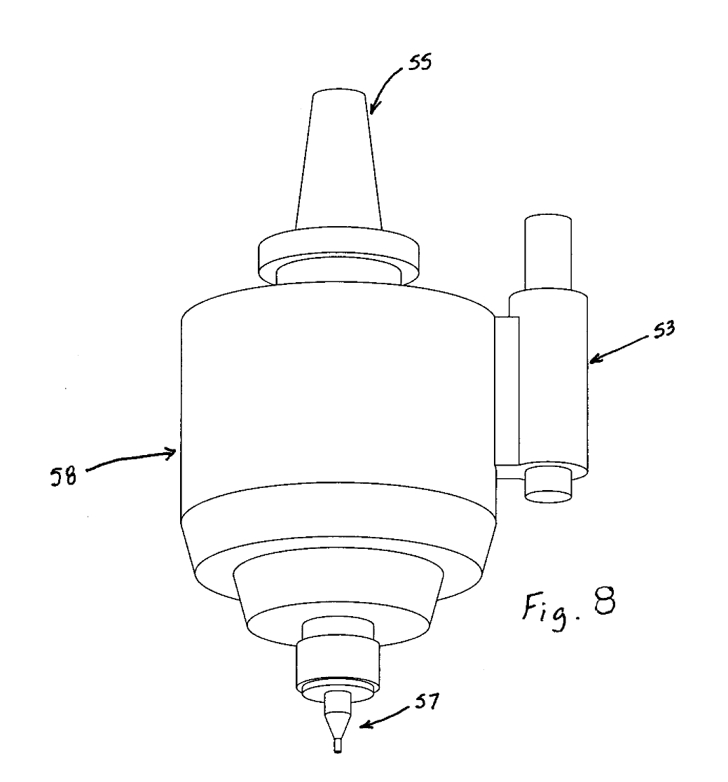

In illustrative embodiments, an interchangeable spindle-speed increaser 58 is provided to increase the spindle speed of general-purpose milling machine 28 as shown in FIGS. 7 and 8. Spindle-speed increaser 58 includes a blocking device 53 and is coupled to a shaft 55 of milling machine 28 and is generally geared to increase the turning speed of a spindle 57 by about 4 to 5 times to between about 20,000 and about 30,000 RPM. Commercially available spindle-speed increasers 58 such as the HYPER-SPINDLE model HP-H may increase the productive through-put of a prototype manufacturing operation by a factor of about 4 or 5 since much of the time in the milling operations for mold-making is spent on finishing cuts with small tool bits.

In illustrative embodiments, the use of a CNC multi-axis horizontal turning centers 60 (otherwise known as computer controlled lathes with live-tools) to produce prototype metal parts and mold inserts for the molding operation is provided as shown in FIGS. 2 and 9. Computer controlled lathes generally have only two operational axes to produce parts which form a surface of revolution.

The illustrative embodiment as suggested in FIG. 9, however, incorporates lathes with live-tools which are electrically driven mills, drills, and taps that can be automatically controlled by the lathe to cut complicated geometries on lathe parts without removing the part from the lathe or “refixturing” the part for a secondary manufacturing operation. Live-tools are able to cut cross-holes in core-pulls and may increase the accuracy of injection molding operations. CNC multi-axis horizontal turning center 60 includes a controller 61 and a work station 59.

The combination of small milling machine 28 with spindle speed increaser 58, vertical clamp molding machine 30 with aluminum molds 34, and manual core-pulls 40 may reduce the cost and increase the speed of prototyping injection molded plastic parts. Incorporation of computer-controlled lathes 60 with live-tools may allow for creation of complex mold cavities and metal inserts for molds 34.

A combination of capabilities may be derived for the current invention by duplicating the milling machines 28 and lathe stations 60 (i.e., providing two milling machines and two computer controlled lathes) so that one station of each type of machine can be in use making prototype molds and parts while another is available for tooling and setup. The use of generally low cost machines may be desirable when purchasing duplicate machinery in a low-profit or non-profit setting.

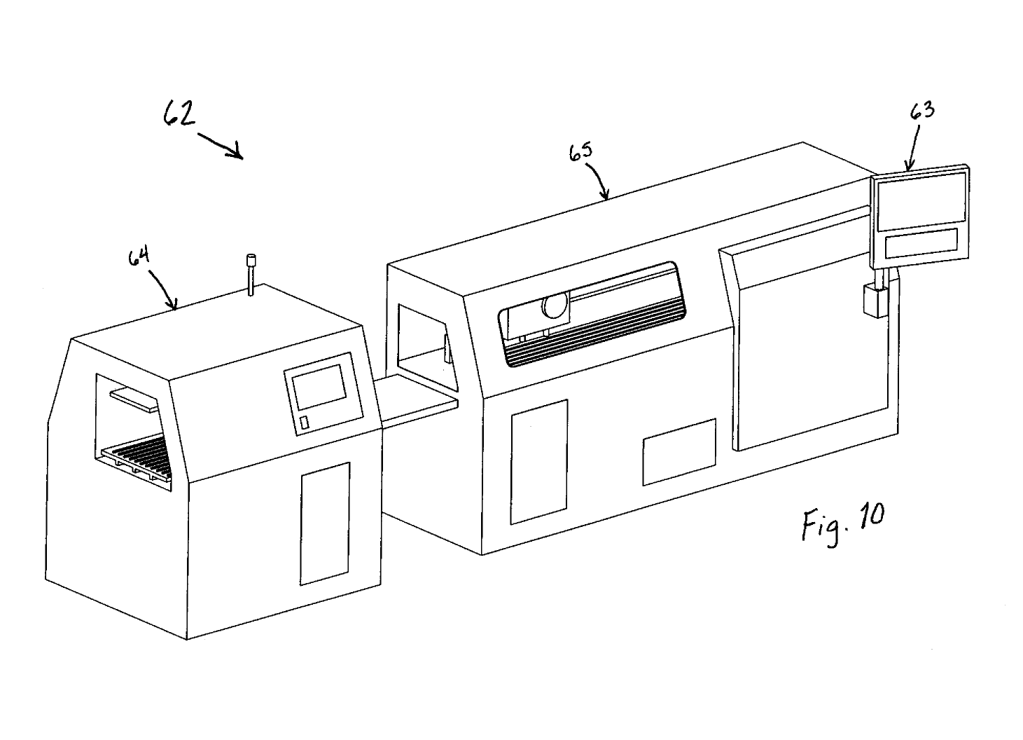

The present disclosure may also include the provision of electronics “pick-and-place” equipment 62 to manufacture prototype electronic circuit boards as shown in FIGS. 2 and 10. Modem electronic components are of a size that makes it difficult to place the parts on a circuit board by hand. The use of pick-and-place equipment 62 in high-speed production operations may be used for prototyping low-quantities of circuit boards. Pick-and-place equipment 62 includes a controller 63 and first and second work stations 64, 65.

The illustrative embodiment may include the use of student labor such as interns and students working on class projects in Computer Aided Design (CAD), computer aided Manufacturing (CAM), circuit design may be employed to program and operate CNC machines 60 to make molds and circuit boards and to assemble molds, fixtures and prototype products and processes. A combination of capabilities may be derived by locating students, technicians of various disciplines in close proximity (such as in a “learning laboratory”) so they can interact with each other and the disclosed equipment to produce prototype products and process for inventors, scientists, engineers and companies desiring to develop and commercialize products, processes and services.

TCC 10 may include a multi-use facility of about 55,000 square feet featuring three tiers of operation spaces. An embodiment of the current disclosure may also include the use of at least three types of build-outs (furnishing levels) in the TCC 10 building. High-cost office spaces may be built-out with carpeting, full ceilings, and professional fixtures to house paying tenants such as start-up companies that use TCC 10 manufacturing services. Profits from the rental of this space may help cover losses in prototyping operations. Open or project space may be used to provide work areas for short term projects and prototype manufacturing processes such as production cells.

1. A method for economically developing and commercializing technology, comprising the steps of
providing a research institution as a source of technology in need of development and commercialization,
providing a manufacturing facility to develop prototype products and processes demonstrating the technology including a mold making facility and a plastic injection molding operation,
obtaining an active profit unit (APU) to pay overhead and operating costs of the captive manufacturing facility, and
obtaining a passive profit unit (PPU) to pay overhead and operating costs of the captive manufacturing facility.

2. The method of claim 1, wherein the source of technology further includes a university including a college of science and engineering having researchers and students and further including the step of manufacturing physical prototypes in the manufacturing facility.

3. The method of claim 2, wherein the PPU is the university.

4. The method of claim 3, wherein the manufacturing facility is substantially located at the university.

5. The method of claim 1, wherein the APU is a manufacturing company.

6. The method of claim 1, further comprising the step of constructing aluminum molds in the mold making facility.

7. The method of claim 6, wherein the step of constructing aluminum molds includes forming the aluminum molds with a computer numerically controlled (CNC) vertical milling machine and an electric discharge machine (EDM).

8. The method of claim 7, wherein an interchangeable spindle-speed increaser is coupled to the vertical milling machine so that a spindle speed of about 20,000-30,000 revolutions per minute is generated.

9. The method of claim 1, wherein the plastic injection molding operation includes a vertical-clamp molding machine having interchangeable mold cavities and manually operated core pulls.

10. The method of claim 1, wherein the step of providing a manufacturing facility further includes that the manufacturing facility is part of the university.

11. A method for economically developing and commercializing technology, comprising the steps of
procuring a source of technology in need of development and commercialization,
providing a captive manufacturing facility to develop prototype products and processes demonstrating the technology,
creating a mold for a plastic injection molding operation to produce the prototype product, and
manufacturing plastic injection molded prototype products in the captive manufacturing facility.

12. The method of claim 11, wherein the mold is made of aluminum.

13. The method of claim 12, wherein the step of creating a mold includes forming the aluminum molds with a computer numerically controlled (CNC) vertical milling machine and an electric discharge machine (EDM).

14. The method of claim 13, wherein an interchangeable spindle-speed increaser is coupled to the vertical milling machine so that a spindle speed of about 20,000-30,000 revolutions per minute is generated.

15. The method of claim 11, wherein the step of manufacturing includes using a vertical-clamp molding machine having interchangeable mold cavities and manually operated core pulls.

16. The method of claim 15, further comprising the step of pulling the cores manually.

17. The method of claim 11, further comprising using pick-and-place equipment to manufacture prototype electronic circuit boards.

18. A method for economically developing and commercializing technology, comprising the steps of
procuring a source of technology in need of development and commercialization,
providing a captive manufacturing facility to develop prototype products and processes demonstrating the technology,
creating an aluminum mold for a plastic injection molding operations to produce the prototype product by use of a computer numerically controlled (CNC) vertical milling machine and an electric discharge machine (EDM), and
molding plastic injection prototype products by use of a vertical-clamp molding machine having interchangeable mold cavities and manually operated core pulls.

19. The method of claim 18, further comprising an interchangeable spindle-speed increaser coupled to the vertical milling machine so that a spindle speed of about 20,000-30,000 revolutions per minute is generated.

20. The method of claim 18, further comprising pick-and-place equipment to manufacture prototype electronic circuit boards.

21. The method of claim 18, wherein the step of procuring includes obtaining a government sponsored research program as a source of technology in need of development and commercialization.

22. The method of claim 18, wherein the step of procuring includes obtaining a student as a source of technology in need of development and commercialization.

23. The method of claim 18, wherein the step of procuring includes obtaining a faculty member as a source of technology in need of development and commercialization.

24. The method of claim 18, wherein the step of procuring includes obtaining a manufacturing partner as a source of technology in need of development and commercialization.

25. A combination of business units for economically developing and commercializing technology, comprising the steps of
a source of technology in need of development and commercialization,
a captive manufacturing facility to develop prototype products and processes demonstrating the technology including a mold making facility and a plastic injection molding operation,
an active profit unit (APU) to pay overhead and operating costs of the captive manufacturing facility, and
a passive profit unit (PPU) to pay overhead and operating costs of the captive manufacturing facility.

26. The combination of claim 25, wherein the source of technology is a university including a college of science and engineering having researchers and students and means to manufacture physical prototypes in a college of technology.

27. The combination of claim 26, wherein the PPU is the university.

28. The combination of claim 27, wherein the manufacturing facility is substantially located at the university.

29. The combination of claim 25, wherein the APU is a manufacturing company.

30. The combination of claim 25, wherein the mold making facility constructs aluminum molds.

31. The combination of claim 30, further comprising a computer numerically controlled (CNC) vertical milling machine and an electric discharge machine (EDM) and wherein the aluminum molds are formed by the vertical milling machine and the electric discharge machines.

32. The combination of claim 31, further comprising an interchangeable spindle-speed increaser coupled to the vertical milling machine so that a spindle speed of about 20,000-30,000 revolutions per minute is generated.

33. The combination of claim 25, wherein the plastic injection molding operation includes a vertical-clamp molding machine having interchangeable mold cavities and manually operated core pulls.

34. A combination of business units for economically developing and commercializing technology, comprising the steps of
procuring a source of technology in need of development and commercialization,
providing a captive manufacturing facility to develop prototype products and processes demonstrating the technology,
creating a mold for a plastic injection molding operation to produce the prototype product, and
providing means for manufacturing plastic injection molded prototype products.

35. The combination of claim 34, wherein the molds are made of aluminum.

36. The combination of claim 35, further comprising a computer numerically controlled (CNC) vertical milling machine and an electric discharge machine (EDM) and wherein the aluminum molds are formed by the vertical milling machine and the electric discharge machines.

37. The combination of claim 36, further comprising an interchangeable spindle-speed increaser coupled to the vertical milling machine so that a spindle speed of about 20,000-30,000 revolutions per minute is generated.

38. The combination of claim 34, wherein the manufacturing means includes a vertical-clamp molding machine having interchangeable mold cavities and manually operated core pulls.

39. The combination of claim 38, further comprising the step of pulling the cores manually.

40. The combination of claim 34, further comprising pick-and-place equipment to manufacture prototype electronic circuit boards.

41. A combination of business units for economically developing and commercializing technology, comprising the steps of
a source of technology in need of development and commercialization,
a captive manufacturing facility to develop prototype products and processes demonstrating the technology,
an aluminum mold for a plastic injection molding operations to produce the prototype product by use of a computer numerically controlled (CNC) vertical milling machine and an electric discharge machine (EDM), and
plastic injection prototype products by use of a vertical-clamp molding machine having interchangeable mold cavities and manually operated core pulls.

42. The combination of claim 41, further comprising an interchangeable spindle-speed increaser coupled to the vertical milling machine so that a spindle speed of about 20,000-30,000 revolutions per minute is generated.

43. The combination of claim 41, further comprising pick-and-place equipment to manufacture prototype electronic circuit boards.
